(19) United States
(12) Patent Application Publication
(10) Pub. No.: US 2004/0010518 A1
(43) Pub. Date: Jan. 15, 2004

(54) Methods and system for a distributed advertiser publishing system in enhanced directory assistance services

(75) Inventor: William A. Montemer, Long Beach, CA (US)

Correspondence Address: William A. Montemer, Suite 120, 24422 Avenida de la Carlota, Laguna Hills, CA, 92653, US

(73) Assignee: INTERCHANGE CORP.

(21) Appl. No.: 10/612,575

(22) Filed: Jul. 2, 2003

Related U.S. Application Data
(60) Provisional application No. 60/394,015, filed on Jul. 3, 2002.

(51) Int. Cl. G06F 17/00; G06F 7/00

(52) U.S. Cl. 707/104.1; 705/14

(57) ABSTRACT

Directory assistance provides telephone number look up services to callers based on the business or caller name as listed in a telephone directory. In the prior art, directory assistance provides a value-added service to telephone users and an expense that must be charged back to telephone users or absorbed by telephone carriers. In enhanced directory assistance (EDA) services as described in the disclosure, EDA is further developed to deliver a keyword targeted advertising service to telephone listing owners and advertisers. The present invention provides a method and system to publish and distribute advertised listings to multiple EDA service providers in a collaborative marketplace. A further object of the invention is to provide methods and systems that increase competition for the most sought-after business keyword categories and provide near-realtime maintenance and placement provisioning for location-based products and services.

### RELATED APPLICATION INFORMATION

This application claims priority from U.S. Provisional Patent Application No. 60/394,015 filed Jul. 3, 2002 and which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention generally relates to the field of telecommunications, and particularly relates to a system and method for providing advertising opportunities in directory assistance systems.

2. Description of the Related Art

Telephone Directory Assistance has been around as long as there have been telephone operators. Once the number of telephone subscribers reached two and three digits, telephone directories were published as service to the large numbers of telephone subscribers. These published telephone directories or books helped both the subscribers and telephone operators locate and contact other telephone subscribers.

There are two types of telephone directories. The White Page-styled directory lists basic telephone contact information for all telephone subscribers; basic listings are free to all subscribers and subscribers are listed by name. The Yellow Page-styled directory lists products and services by category, to be included in a Yellow Page directory an advertiser must pay a fee. The Yellow Page directory advertiser pays for both the size of the advertisement or listing and for its inclusion in one or more specific categories.

Traditional directory assistance service provides telephone number look up to the White Page style directory. Enhanced directory assistance service provides look up to a Yellow Page style directory. The difference between the two is based on how a caller finds a particular directory listing.

In a traditional directory assistance service, the caller contacts a directory assistance operator and gives the operator the name of a business or person and its associated locale. The directory assistance operator then searches a telephone directory database for a telephone listing that matches the sought-after criteria. Upon finding a match or a set of matches, the operator informs the caller and either gets further information to narrow the results or offers to connect the caller to a desired telephone number.

In an enhanced directory assistance system, a caller contacts a directory assistance operator and in addition to providing as some localization information to narrow where the caller wishes to find the product or services, the caller provides a category name or keyword associated with the desired product or service. In the present art, an enhanced directory assistance operator then takes the provided information and searches or queries a Yellow Page-styled directory. Upon finding a match, the operator informs the caller and either gets further information to narrow the results or offers to connect the caller to the desired telephone number.

In the present art, inclusion in these paid listings is offered to a business or organization through monthly or yearly subscription fees. Also in the present art, listing partners can pay a premium fee to be listed at the top of a category or keyword lookup result list. The premium or preferred listing is given priority treatment by the directory assistance operator and mentioned before any other paid listings are communicated.

In the current art, book directories are published and distributed as local resources Every directory, whether it's a white pages or a Yellow Pages styled one, covers a single local area.

Electronic EDA directory listings are much more global, while still advertising local resources. Also, each EDA publisher services his own clients.

The present invention provides methods and systems that allow publishers to share resources easily as well as build and support collaborative business systems.

### BRIEF DESCRIPTION OF THE DRAWINGS

FIG. 1 shows a system block diagram of a distributed Enhanced Directory Assistance (EDA) Listing Service.

FIG. 2 shows a system block diagram of a distributed EDA Listing Network.

FIG. 3 details a sample distributed EDA listing inquiry and a set of results.

FIG. 4 shows a system block diagram an embodiment of a distributed EDA Business Transaction.

FIG. 5 details a distributed EDA revenue sharing transaction message system.

FIG. 6 shows a conceptual view of a distributed EDA listing maintenance model.

FIG. 7 shows the near real time listing placement provisioning of a distributed EDA listing service.

FIG. 8 shows the proximity placement provisioning of a distributed EDA listing service.

### DETAILED DESCRIPTION OF THE INVENTION

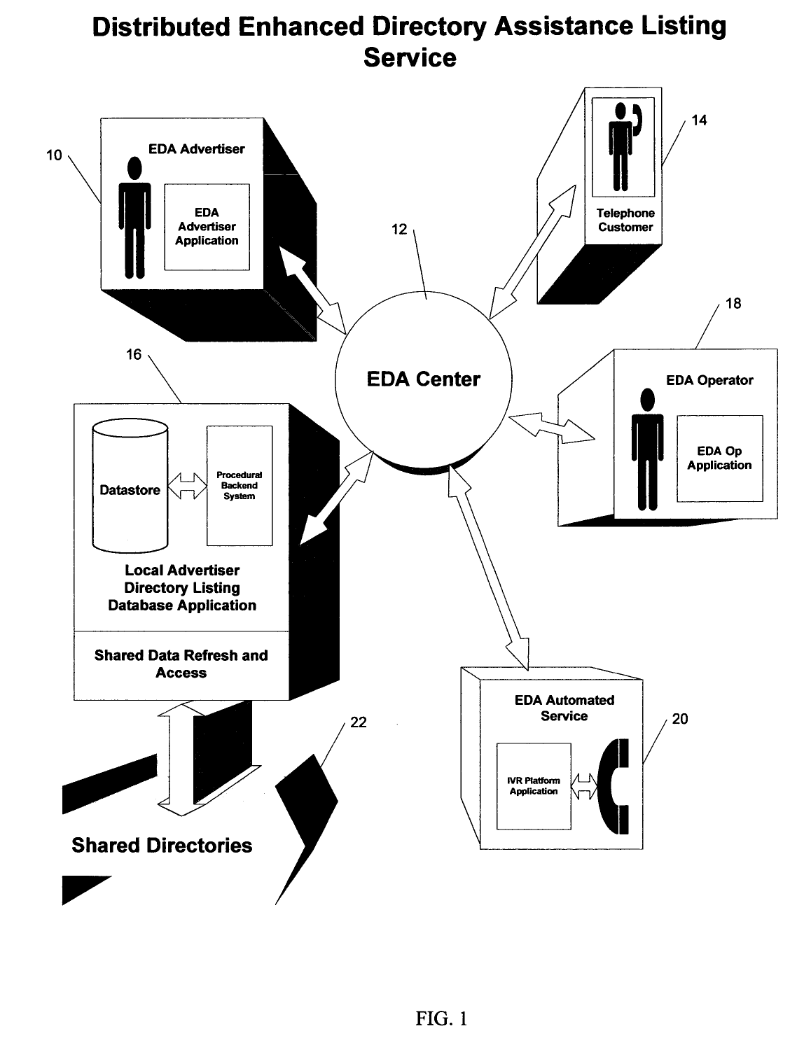

Enhanced Directory Assistance (EDA) services provide opportunities for telephone listing owners and advertisers to promote products and services to telephone callers looking for those products and services. In reference to FIG. 1, the illustration shows such an EDA Listing Service. In the embodiment, an EDA Advertiser 10 owns a set of telephone directory listings that are maintained at the local EDA Center 12, in a Local Advertiser Directory Listing (LADL) Database 16. Each directory listing in the LADL is associated with one or more keywords.

The operation of the EDA Listing Service is straightforward. The EDA Advertiser agrees to pay the EDA Center provider a predetermined amount of money for every telephone referral the advertiser receives from the EDA Center. The EDA service discussed here can rightly be called a paid referral service.

The LADL database contains directory listings belonging to the EDA Advertiser clients of the particular EDA Center. These listings are locally maintained and controlled. Next, at predetermined times, these local listings are published into a system of Shared Directories 22. The Shared Directories effectively comprise a “read-only” database of listings that can be cached and distributed independently of the LADL data.

Once published as Shared Directories, the listings are aggregated and sorted with listings from other EDA Centers. This architecture enhances scalability and performance by separating data that must be maintained from the distributed data. The two sets of data can be kept in sync by defining refresh rules and a data recycling architecture.

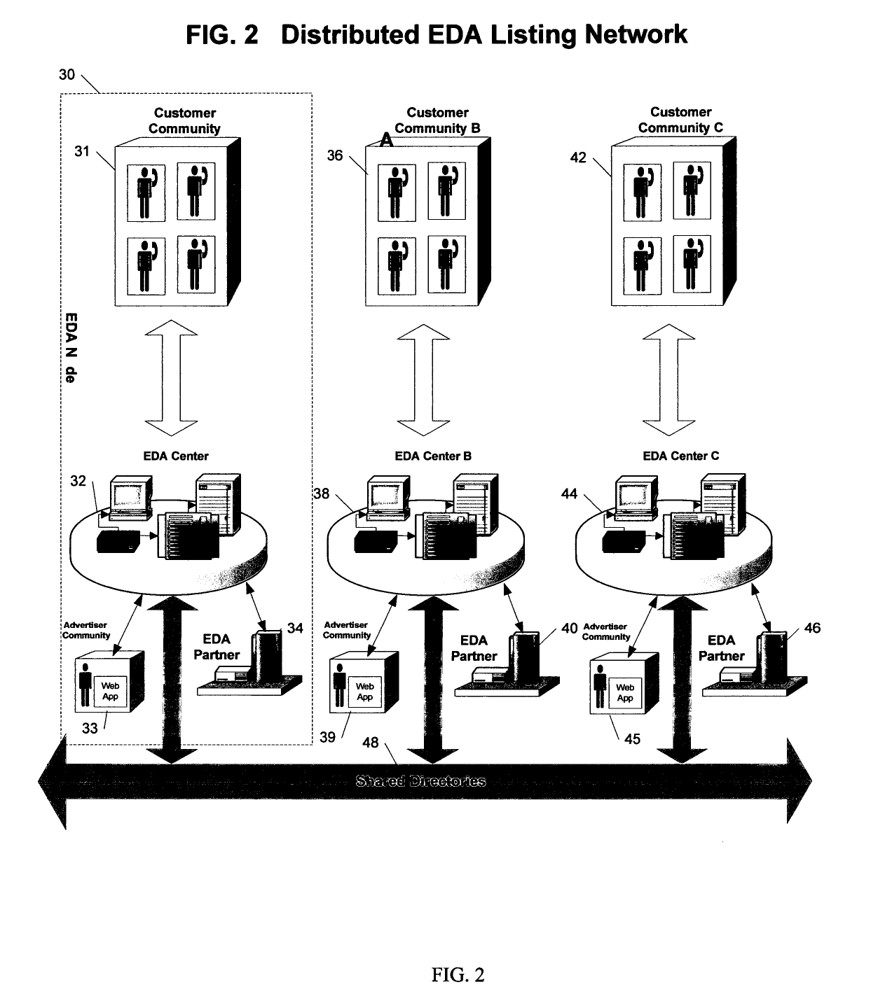

The records in the shared directories are read/write resources that are “written or updated” and “read” by the EDA Center and any other EDA Centers or “nodes” on the EDA network. FIG. 2 details the relationship of an individual EDA Center and a network of EDA nodes that share access to the shared directories.

Each of the shared directory listings contains content information (Listing ID, Listing Description, Referral Phone Number), owner information (Advertiser ID, EDA Provider ID), business transaction information (Referral Amount, Business Rule ID), as well as keyword identifiers.

In reference to FIG. 1, when a Telephone Customer 14 dials a predetermined EDA number, the EDA Center assigns the call to an EDA Operator 18. After determining the geographical location of the customer, the operator obtains a keyword from the customer, thereby identifying the product the customer is seeking.

The operator then submits the keyword to the LADL database application. The LADL application in turns queries the shared directory data and returns a list of advertised telephone listings for the particular keyword submitted. The individual referrals can be organized in any number of ways. In one embodiment, the referral list is organized by the highest to lowest amount paid for each referral. In this embodiment the EDA operator recites the list to the customer, who selects one of the referral items.

In another EDA Listing Service embodiment, the functions of the EDA Operator can be done by an Interactive Voice Response (IVR) system 20. In an IVR embodiment a series of voice dialogs could be constructed using any number of well-known Voice XML (VXML) platforms. As before, the IVR system presents the customer with a set of referrals and the customer selects one.

The final result of an EDA inquiry is a telephone referral. In the referral, the inquiry call is transferred to the selected advertised directory listing referral number and a referral business transaction is initiated.

Distributed EDA Listing Network

FIG. 2 illustrates how the directory listings of an individual EDA Center can be pooled together with the listings from other EDA Center entities or EDA nodes. Each EDA node can be considered a separate publisher of directory listings or a publishing entity.

In reference to FIG. 2, an EDA node 30 consists of a Customer Community 31, an EDA Center 32, an Advertiser Community 33 and zero or more EDA Partners 34. In one embodiment, an EDA Partner may be a content publisher such as a Yellow Pages (YP) Directory company who publishes YP listings into the EDA system. In this instance, the YP publisher's listing data is imported into the EDA Center's LADL database.

Once the advertiser listings are imported into the LADL database, the data is manipulated into a form that is compatible with the native LADL data. At this point, the listing data can be published as a Shared Directory 48 resource.

In like manner, EDA Center B services Customer Community B, and EDA Center C services Customer Community C. Both EDA Center B and EDA Center C have their own Advertiser Communities 39, 45 and EDA Partners 40, 46. Also, each EDA Center publishes into the Shared Directory system.

In one preferred embodiment a distributed EDA Listing Network can be built from separate and distinct publishing entities. By separating locally maintained data from the shared directory data, the Distributed EDA system can support multiple data platforms whether they are older legacy architectures or newer systems ones developed from the ground up.

Distributed EDA Listing Results

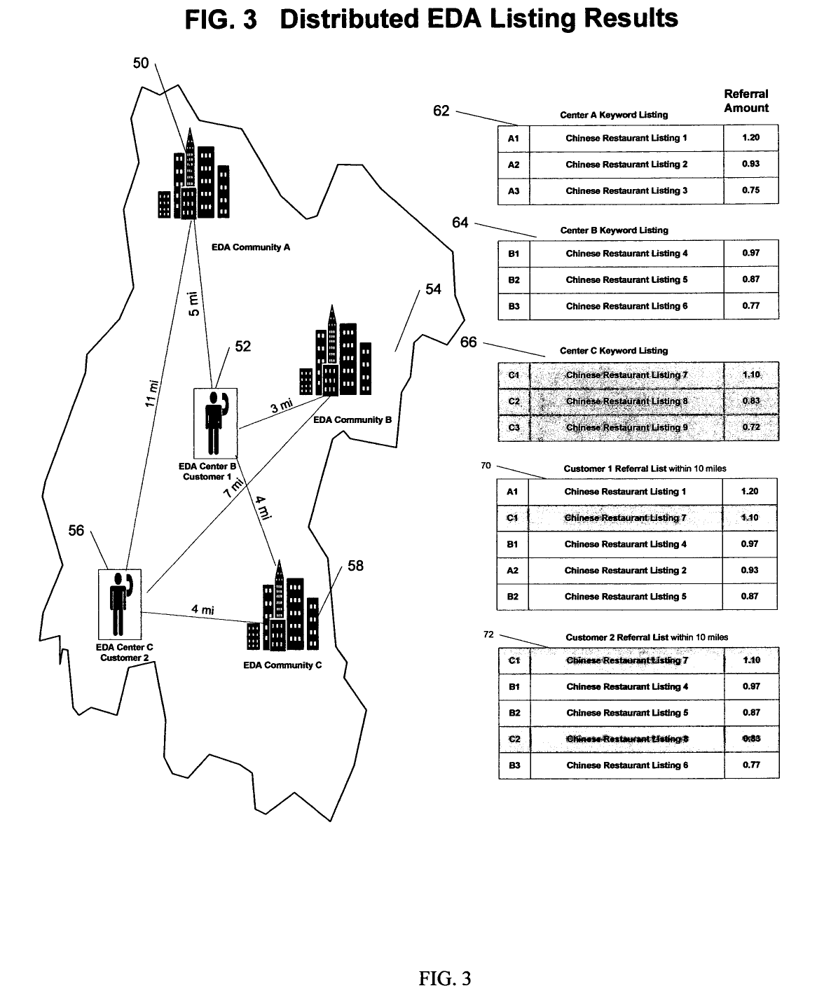

FIG. 3 illustrates sample listing results for one embodiment of a distributed EDA system. The system encompasses three different communities—Community A 50, Community B 54, and Community C 58. A separate EDA center—Center A, Center B and Center C respectively—services each community.

The drawing also shows two EDA customers. Customer 1 lives 3 miles from Community B, 5 miles from Community A, and 4 miles from Community C. EDA Center B services Customer 1. Customer 2 lives 4 miles from Community C, 7 miles from Community B, and 11 miles from Community A. EDA Center C services Customer 2.

Tables 62, 64, and 66 show the top 3 listings (sorted by paid referral amount) for the keyword Chinese restaurant for each EDA center. In other words, table 62 shows that listing A1 is first at $1.20, followed by listing A2 at $0.93 and A3 at $0.75. Similarly table 64 shows Center B's top 3 to be B1 at $0.97, B2 at $0.87 and B3 at $0.77. Table 66 shows Center C's list as C1 at $1.10, C2 at $0.83 and C3 at $0.72.

In the preferred embodiment, the three EDA Centers pool their listings as shared EDA directories and offer them to all their EDA customers. Also in this sample embodiment, the EDA centers employ an arbitrary rule where referred listings must be within 10 miles of the caller. As will be demonstrated later, applying additional business rules to the list generation process allows shared EDA listings to be more finely targeted.

Table 70 shows the top 5 listing results delivered to customer 1 in response to the keyword inquiry “Chinese restaurant”. Listing A1 from Center A at $1.20 is in first position followed by: Listing C1 from Center C at $1.10; Listing B1 from Center B at $0.97; Listing A2 from Center A at $0.93; Listing B2 from Center B at $0.87. Note that the returned listings are mixed and come from all three EDA Communities.

Table 72 shows the top 5 listing results delivered to customer 2 by the same keyword inquiry. Here, first position belongs to Listing C1 from Center C at $1.10 followed by: Listing B1 from Center B at $0.97; Listing B2 from Center B at $0.87; Listing C2 from Center C at $0.83; Listing B3 from Center B at $0.77. These results are also mixed but do not include any listings from EDA Center A because customer 2's proximity is greater than the 10 mile business limit. Note also that the absence of Center A's listings has created opportunities for listings C2 and B3 to be included in the result list.

Distributed EDA Business Transaction Model

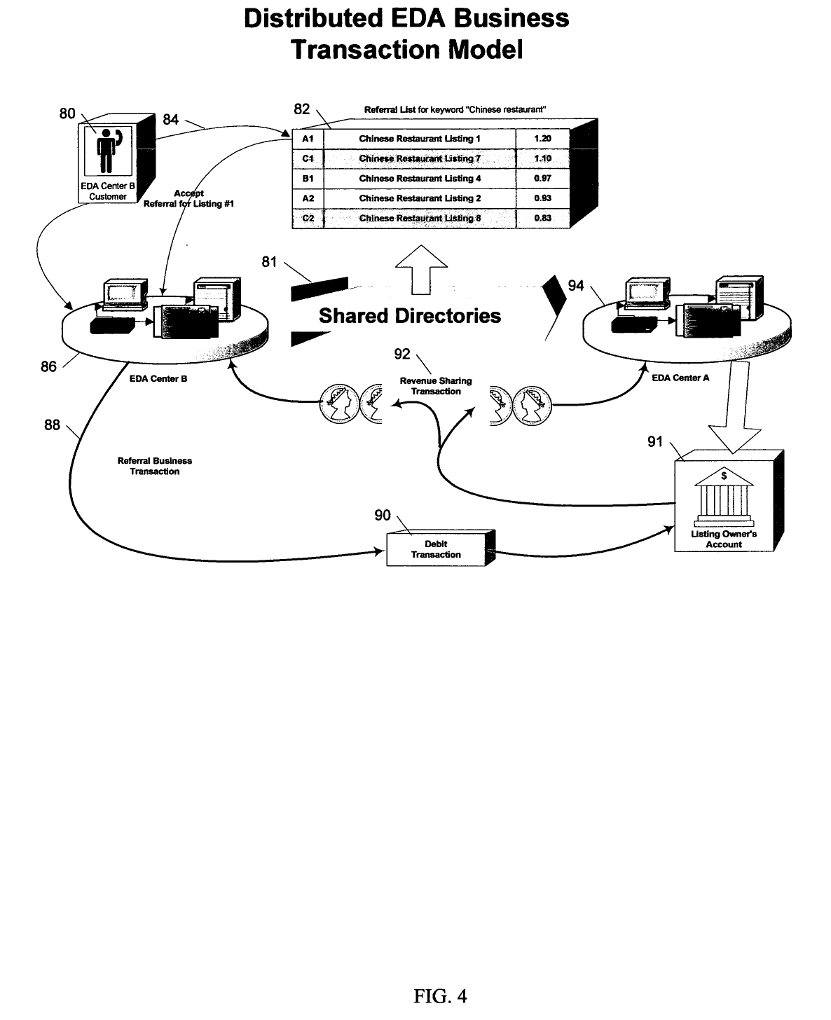

FIG. 4 illustrates how the Distributed EDA Business Transaction Model works. The drawing continues the scenario illustrated in FIG. 3. In reference to FIG. 4, an EDA customer 80—who is calling via EDA Center B 86—requests an EDA inquiry on the keyword “Chinese restaurant.” EDA Center B accesses the pool of Shared Directories 81 and returns Referral List 82 with the listings as shown.

Suppose the customer accepts the referral for Listing #1 84 which is Listing A1 from EDA Center A 94 at $1.20. At this point EDA Center B transfers the customer's call to Listing A1's referral phone number and initiates a Referral Business Transaction 88.

The referral business transaction can be quite complex depending on the business relationship between the EDA Center and its partners. In one embodiment, the referral business transaction involves executing a Debit Transaction 90 on the Listing Owner's Account 91. Because Listing A1 is provided by Center A, Center A executes a Revenue Sharing Transaction 92. The amount debited from listing A1's owner account is split and added to the revenue accounts of both Center A and Center B.

In the model illustrated by this embodiment, both shared directory partners support and benefit from the referral transaction.

Distributed EDA Revenue Sharing Message System

As shown by the preceding embodiment of the Distributed EDA Transaction Model, transactions occur across both physical and infrastructure domains. The distributed nature of these transactions means that delays can and will occur that may cause performance problems.

For instance a single referral business transaction can be composed of multiple smaller transactions. Correlating the results of these all or nothing transaction sets requires a new approach to system design and interaction. The application of these new techniques and technologies falls under a new development paradigm known as web services.

In web services, the interacting systems are coupled asynchronous systems, as opposed to tightly coupled synchronous ones. The loose coupling allows parts of the system to work independently so that, for instance, a collection buffer is continually available to receive input, while a corresponding execution service that processes the input works more slowly.

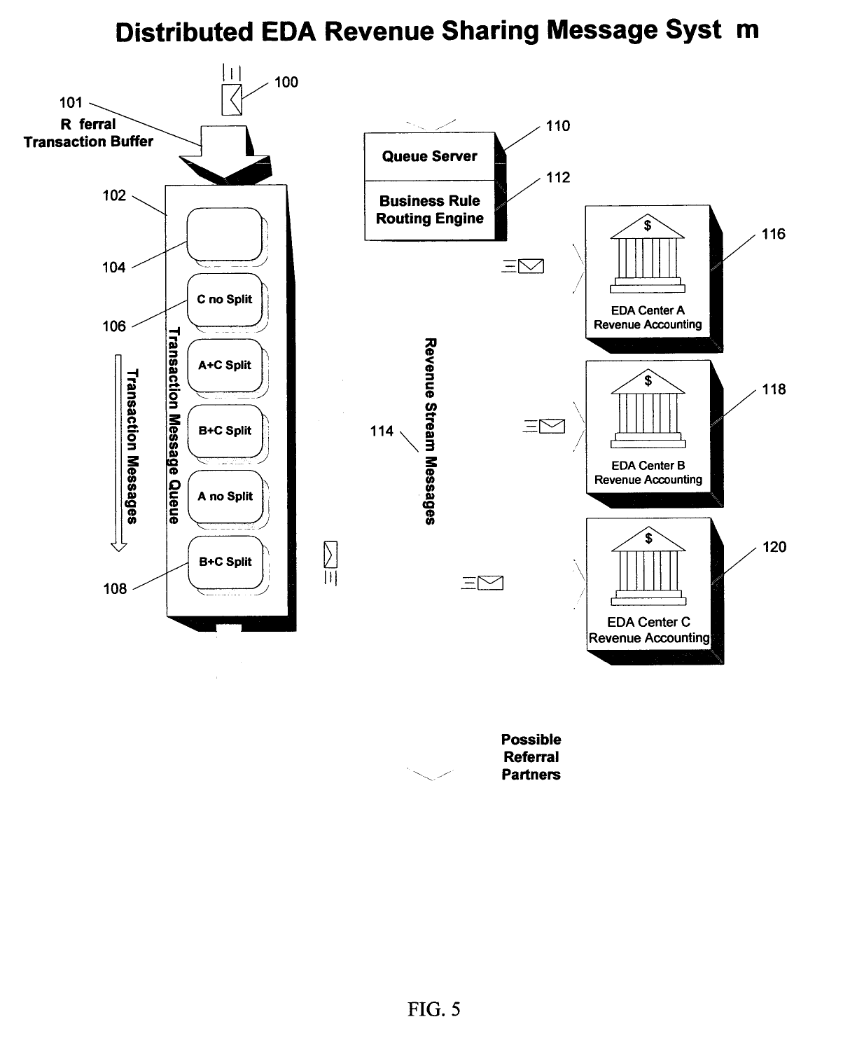

Messaging systems have long been deployed in the art to satisfy these kinds of requirements. FIG. 5 illustrates an embodiment of a Distributed EDA Revenue Sharing Message System. Referring to the embodiment in FIG. 5, a distributed revenue sharing system consists of a Transaction Message Queue 102, a Queue Server 106, a Business Rule & Routing Engine 108 and access to partner's Revenue Accounting Systems 112, 114, and 116.

The system starts with transaction messages 100 being delivered to the Referral Transaction Buffer 101 of the Transaction Message Queue 102. The queue is a first in first out (FIFO) device that holds a stream of transaction message containers or cells 104 through 108 waiting to be processed. In the illustration, cell 104 is an empty container waiting to receive a transaction message while the 106 through 108 cells are filled with revenue-split transaction data.

The contents of a transaction message can include both transaction data and transaction metadata—data that defines the transaction. In one embodiment the transaction message can include transaction compensation metadata to be used in the event of a transaction failure condition or “rollback”.

In one preferred embodiment, the transaction message queue cells contain revenue split data that defines how the referral amount will be divided between the EDA partners. In the detailed embodiment, the message cells are processed one by one by a Queue Server 110. The processed data is then input to a Business Rule Routing Engine (BRRE) 112 that is used to address or redirect the message to the various partner Revenue Accounting systems 116, 118 and 120.

In the detailed embodiment, the revenue transaction messages 114 are streamed to the partner accounting systems. For instance a “C no split” transaction 106 would be delivered to the EDA Center C accounting block 120, while a “B+C split” transaction 108 might be equally divided between EDA Center B and Center C.

Listing Maintenance Distribution Model

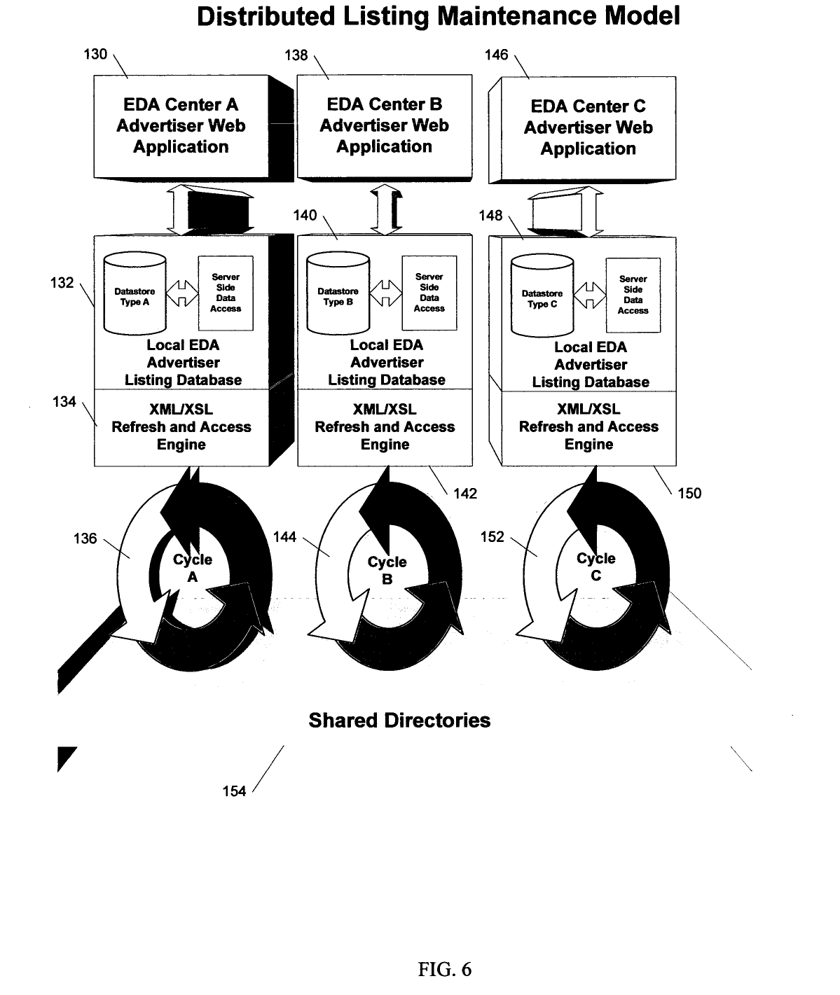

FIG. 6 illustrated a Listing Maintenance Distribution Model for a distributed EDA Listing service. This drawing illustrates how the distributed model allows differing data infrastructures with differing business configurations and operations to participate in sharing EDA directory listings.

In one preferred embodiment referring to FIG. 6, three EDA Centers—EDA Center A 130, EDA Center B 138 and EDA Center C 146—publish and maintain Local EDA Advertiser LADL databases 132, 140 and 148 and the associated advertiser accounts. Each center uses a different type of data storage system to maintain their LADL databases. EDA Center A uses a Type A system—perhaps like SQL Server. EDA Center B uses a Type B system—perhaps like Oracle. And EDA Center C uses a Type C system—perhaps a native XML database.

While the native format of each publisher's database differs, using XML and XML Style Language (XSL) technologies, their data can be transformed into a compatible format that can be published into the Shared Directories 154. The transformation process for each system occurs in the XML/XSL Refresh and Access Engine (XRAE) 134, 142 and 150. In the embodiment disclosed, XRAE controls both the data transformation and the data refresh cycle (how often the shared data is refreshed). For instance, the refresh cycle of EDA Center A—Cycle A 136—might be every two hours. At the same time Cycle B 144 is refreshed by a batch process that runs every 12 hours. Finally the newly designed system in EDA Center C—Cycle C 152—might be efficient enough to run every fifteen minutes.

The preferred embodiment of the distributed listing maintenance model demonstrates that the asynchronous design of a loosely coupled distributed EDA listing service eases the integration tasks even among disparately designed EDA publishing entities.

Near Realtime Listing Placement Provisioning

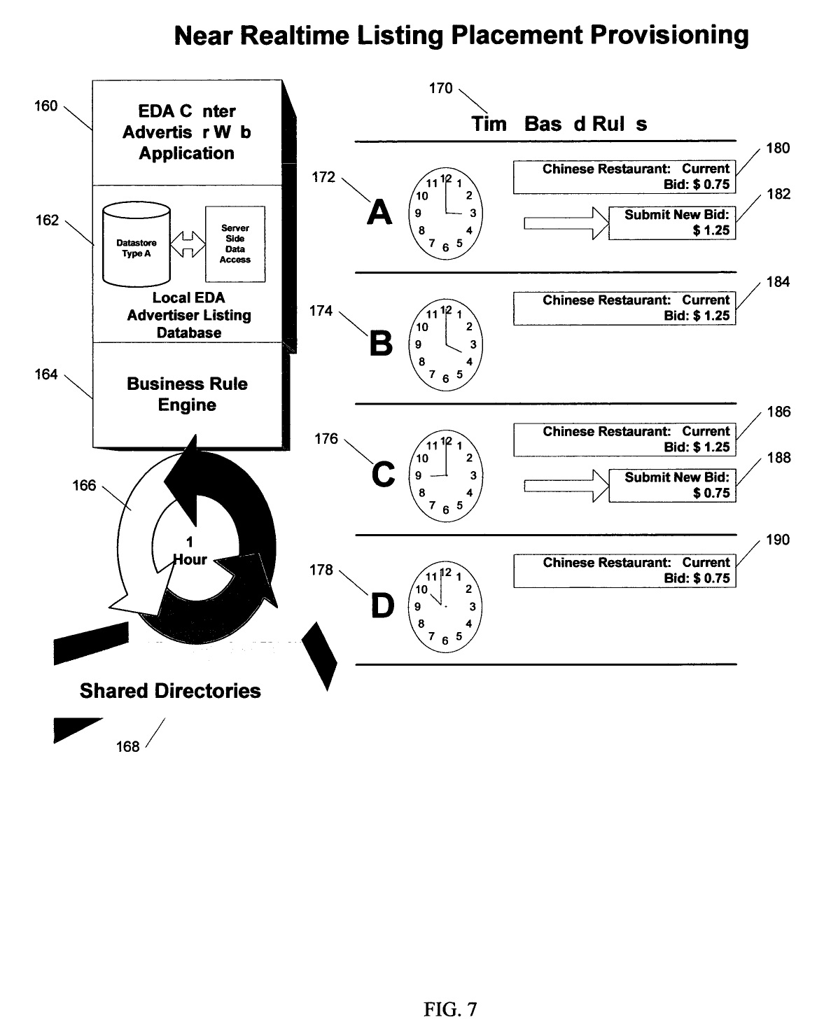

FIG. 7 illustrates how a distributed EDA Listing service provides for near realtime listing placement. The ability of the system to link referral advertising costs to specific time slots increases the targetability and hence the value of the referral as an advertising resource. The added targeting features allow advertisers to compete more effectively for the more popular referral keywords.

In reference to FIG. 7, an EDA publisher and provider operates an EDA Listing service using a preferred embodiment, including an Advertiser Web Application 160 and a Local EDA Advertiser Listing database (LADL) 162. Additionally, the EDA service employs a Business Rule Engine (BRE) 164 that allows the listing owners to fine-tune how and when their listings appear in referral lists. As before the EDA Center publishes its LADL data out to the Shared Directories network 168 on a one-hour cycle 166.

Well known in the present art, a business rules engine is a decision support system that selects appropriate outcomes based on input data. Using logical constructs, the system efficiently determines what should be done given various sets of conditions or input.

Suppose an Chinese restaurant owner (The Lucky Dragon) is bidding for top placement on the keyword “Chinese restaurant”. Also suppose that the restaurant offers special dishes and special drinks during the dinner or “peak hours” (approximately 4:00 to 9:00 pm). In the illustrated embodiment, the BRE monitors the time of day and changes and redistributes the referral amount paid for the “Chinese restaurant” keyword according to the bid parameters set by the owner.

The Time Based Rules chart 170, shows the bids set up by the owner for this scenario. During non-peak hours, the listing advertiser is willing to pay $0.75 for each referral. We can assume that this bid places the referral in position 3 or 4 on a typical day. During peak hours (4 to 9 pm), the listing advertiser is willing to pay $1.25 per referral. We assume that this bid will make the restaurant listing appear at the top of the list.

As shown in the chart, in segment A 172 the time is 3:00 pm and the current bid 180 paid for a “Chinese restaurant” referral is $0.75. At that time the system submits a new bid of $1.25. The EDA Center system refreshes its published listings every hour. As shown in segment B 174, at 4:00 pm and the current bid will be $1.25 and the listing now appears at the top of the referral list. This means that EDA customers looking for a Chinese restaurant are offered a referral to the Lucky Dragon first.

At approximately 9:00, as shown in segment C, the bid is $1.25. Also, the listing owner has scheduled a new bid of $0.75 to be entered. After one hour, when the system refreshes its bids, the new bid is redistributed on the shared directory network. Segment D 178 shows that the current bid is once again $0.75.

In an alternative embodiment, the same result as the time based rules could be implemented by manually submitting new bids at the appropriate times. Another embodiment would be for the advertiser to use a smart client application that automatically submitted new bids as instructed by the listing owner.

Proximity Listing Placement Provisioning and Smart Distribution

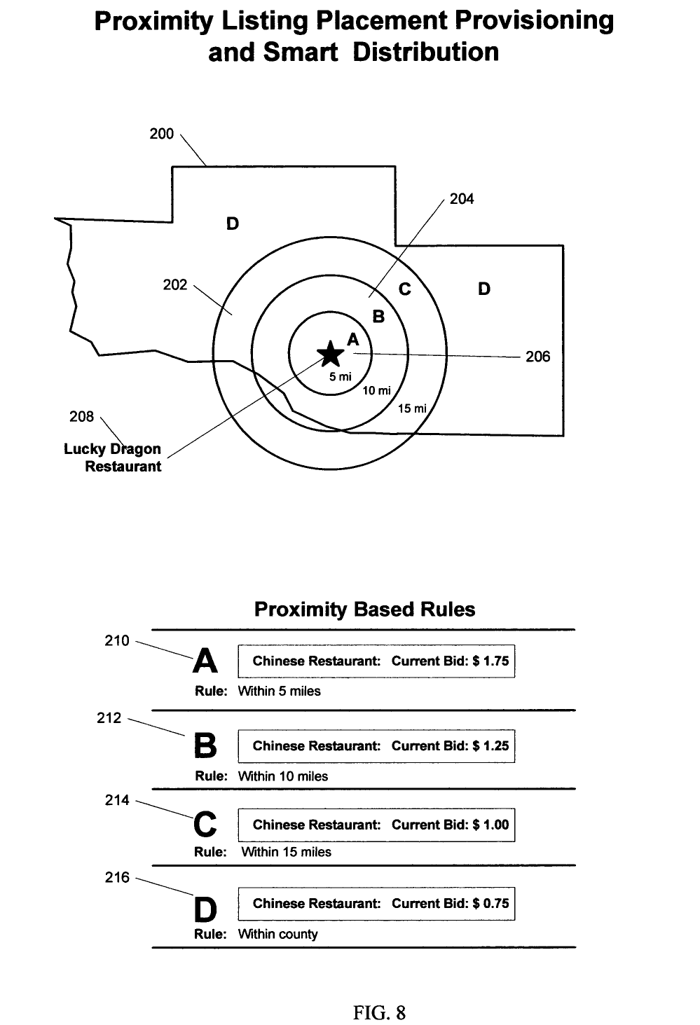

FIG. 8 illustrates how a distributed EDA Listing service provides for proximity listing placement. Incorporating proximity rules into the generation of EDA referral lists allows for distribution to be implemented in a more intelligent way. The added targeting features enhance the number of listing placement positions available as well as enhances the quality of the referral allowing advertisers to compete more effectively for the more popular referral keywords.

In one preferred embodiment shown in FIG. 8, the Lucky Dragon Restaurant 208 has set up a series of bids for the keyword “Chinese restaurant”. There are four different areas the restaurant owner is willing to target for EDA referrals. Area A 206 is within 5 miles of the restaurant. Area B is beyond area A but within 10 miles; area C is beyond area B but within 15 miles. Finally area D is within the county lines but beyond area C.

As shown in the Proximity Based Rules chart, the owner is willing to pay $1.75 for referrals within area A or 5 miles of the Lucky Dragon. For referrals within area B, the owner will pay $1.25. For referrals within area C, the bid amount is $1.00 and within area D the bid is $0.75.

Since the cost per referral affects the referral list placement and the placement affects the Return on Investment (ROI), adding proximity parameters to the EDA bidding mechanism allows listing advertisers to justify their higher bids.

It is claimed:

1. A method of sharing directory listings in a distributed environment using a computer network comprising:
maintaining a database including a plurality of directory listings, wherein each listing is associated with a referral phone number, at least one keyword and a bid amount;
a directory listing owner is willing to pay for a single telephone referral;
publishing directory listings into a shared data system;
receiving a directory assistance request in the form of a keyword from the customer;
identifying the directory listings from the shared data system having keyword terms generating a match with the request;
ordering the identified directory listings into a phone number result list in accordance with the values of the bid amounts for the identified directory listings;
selecting one of the directory listings;
generating a paid referral business transaction and associating it with the listing owner's advertising account;
generating one or a plurality of derivative business transactions to execute the business processes involved in the referral transaction.
